(19) United States
(12) Patent Application Publication
(10) Pub. No.: US 2009/0027463 A1
(43) Pub. Date: Jan. 29, 2009

(54) WIDE FORMAT INK CARTRIDGE

(76) Inventor: Richard H. Berg, Hilton, NY (US)

Correspondence Address: FAY SHARPE LLP, 1100 SUPERIOR AVENUE, SEVENTH FLOOR, CLEVELAND, OH, 44114, US

(21) Appl. No.: 12/178,990

(22) Filed: Jul. 24, 2008

Related U.S. Application Data
(60) Provisional application No. 60/961,779, filed on Jul. 24, 2007.

(51) Int. Cl. B41J 2/175

(52) U.S. Cl. 347/86

(57) ABSTRACT

An ink cartridge has a plurality of walls forming an internal cavity which is substantially filled with ink, and an ink supply flow path provided in one of the walls of the ink cartridge. An ink supply port is provided in another of the walls of the cartridge, wherein the ink supply flow path connects to the ink supply port. The ink supply flow path includes a first compartment and a second compartment. The first compartment houses a wicking member, and the second compartment is configured to trap air bubbles formed in ink as it travels through the ink supply flow path.

### CLAIM OF PRIORITY

This patent application claims priority from U.S. Provisional Patent Application No. 60/961,779 filed on Jul. 24, 2007, the contents of which are incorporated herein by reference.

### BACKGROUND OF THE INVENTION

The present invention relates to an ink cartridge and an ink cartridge holder. More particularly, the present invention relates to the ink cartridge for supplying ink to a recording apparatus.

Generally, an ink jet recording apparatus is designed to print data by causing the recording head to move back and forth along the width of a recording sheet. Ink is supplied from an ink supply source to the recording head. As a result, the ink jet recording apparatus that must produce a large number of copies must carry a larger-sized ink cartridge which cannot be mounted on a carriage. Thus, the ink cartridge is mounted on the housing of the recording apparatus, and the ink may be supplied to the recording head through a tube.

An ink jet recording apparatus can be provided which includes an ink cartridge holder on which an ink cartridge filled with ink is detachably mounted. A large-size ink cartridge is used for the ink jet recording apparatus which records on large-size papers, such as posters or the like, in order to cope with a large quantity of ink consumption.

The ink cartridge used for the ink jet recording apparatus may be provided with a memory device or chip which stores information, such as a type of ink, color of ink, remaining amount of ink and the like. An information reading section is provided on the ink cartridge holder at a position facing the chip when the ink cartridge is mounted on the ink cartridge holder, and the chip on the ink cartridge and the information reading section on the ink cartridge holder are electrically connected and communicate with each other.

Existing wide format ink cartridges often have a bag or collapsible ink reservoir contained within a rigid housing. An example of such a cartridge is shown in U.S. Pat. No. 6,053,606. A problem with this arrangement is that as the bag collapses, pockets of ink become trapped in the bag, thus reducing the efficiency of the cartridge. Also, air bubbles may form in the ink supply port, and become trapped as well, which may result in imaging defects at the printer.

The printer is designed to allow the customer to remove the cartridge to swap out different colors within the same port. Every time the cartridge is re-inserted into the printer, air is injected into the cartridge and positioned within the same compartment where the ink needle will be. This will provide the opportunity for air to be suctioned into the printer's ink line and create imaging defects such as missing jets or the entire color to deprime. Each cartridge insert adds significantly more air into the cartridge, thus, drastically accelerating printing failure. As the ink is consumed from printing, it can be expected that the customer will swap different colors based on the design of the printer. If the cartridge is laid on its side where the ink inlet is at the elevated position, air will enter into the ink fluid channel due to density of the two fluids. Upon re-inserting this cartridge back into the printer's port, the air due to buoyancy will float into the horizontal chambers where the printer's ink needle is located.

Trapped air bubbles in the ink fluid path are suctioned into the printer's ink. This trapped air results in missing jets or depriming of the entire color in the printing images.

There are at least four ways for bubbles to be formed in compartments of the ink fluid flow path of the cartridge. A first way is during ink filling of the cartridge, which may leave initial air bubbles in the fluid path section. If the cartridge is vacuum filled, air will be left behind in the cartridge after filling the cartridge. The air enters into the ink fluid flow path of the cartridge by orientating the air bubbles at the inlet. A second way that air bubbles are formed is during packaging and shipment of the cartridge. A third way is if the cartridge is laid flat on the table, air bubbles will wick into the fluid passage and float forward and possibly deprime the cartridge.

Fourth, as the cartridge is inserted into the printer, the design of the septum or valve in the ink supply port will trap free air as the ink travels from the cartridge to the printer. The rubber septum has a cylindrical cavity but seals to the outer diameter of the printer's ink needle by a compression fit. The nose of the printer's ink needle is typically a tapered cylinder which traps the air in the cylindrical volume of the rubber septum. This trapped air is squeezed into the ink cartridge's fluid compartment(s).

Thus, there is a need for a geometry of the ink fluid flow path which would overcome the foregoing difficulties while providing better and more advantageous overall results.

### SUMMARY OF THE INVENTION

The present invention relates to an ink cartridge. More particularly, it relates to a wide format ink cartridge for use with an ink cartridge holder. The wide format cartridge contains ink in a box-like cavity. Air will reside in the box for such reasons as volumetric expansion of the ink, such as the ink expanding during freeze testing to survive shipping. Also, air may be entrained into the fluid channel where the air can be suctioned into the ink needle of the printer.

The existing fluidic geometry of ink cartridges results in a bubble positioned in a first compartment of the ink supply flow path exhibiting a drag force; and, thus, a negative pressure gradient results, pulling the bubble(s) into the ink. With an improved fluid flow geometry, there is no significant drag force on the simulated bubble, and there is no significant pressure gradient formed around the bubble.

In the improved compartment geometry air trapped upon insertion into the printer will enter a second, additional compartment. Air bubbles will float to the top of the new reservoir or compartment.

The improved flow path geometry results in no significant flow around a bubble positioned close to the flow path. The improved geometry results in virtually no pressure gradient surrounding the bubble. An inlet filter and wicks in the first compartment significantly reduce air ingestion without affecting image quality.

First and second compartments are combined into one bubble trap reservoir where the bubbles will float away from the ink needle. The second compartment may also have a sloped upper wall or ceiling. The slope of the ceiling must have enough slope to allow the bubbles to slide and not stick to the surrounding surfaces. The internal surfaces are preferably smooth, not rough, which will help in minimizing the amount of slope surface in order to have enough room for the valve design space.

In accordance with one aspect of the invention, an ink cartridge has a plurality of walls forming an internal cavity which is substantially filled with ink and an ink supply flow path is provided in one of the walls of the ink cartridge. An ink supply port is provided in another of the walls of the cartridge, wherein the ink supply flow path connects to the ink supply port. The ink supply flow path includes a first compartment and a second compartment, wherein the first compartment houses a wicking member, and the second compartment is configured to trap air bubbles in ink as it travels through the ink supply flow path.

One aspect of the present invention is the provision of providing two chambers in an ink supply flow path of an ink cartridge to trap bubbles formed in the ink.

Another aspect of the present invention is the provision of a reservoir formed in the second compartment which is longer and larger than the first compartment to trap bubbles and prevent the bubbles from traveling through the ink flow path in an ink supply path for preventing bubbles from forming in the ink.

Another aspect of the present invention is the provision of an ink cartridge which has a second compartment with a sloped surface for preventing bubbles from sticking to a surface of the compartment.

Other aspects of the invention will become apparent upon a reading and understanding of the following detail description.

### BRIEF DESCRIPTION OF THE DRAWINGS

The foregoing advantages of the present invention, and others, will in part be obvious and in part pointed out more fully hereinafter in conjunction with the written description of the embodiments illustrated in the accompanying drawings in which:

FIG. 1 is a perspective view of a front side of an ink cartridge in accordance with a first embodiment of the present invention;

FIG. 2 is a partial elevational view of a side wall of the ink cartridge of FIG. 1;

FIG. 3 is a front elevational view of a front wall of the cartridge of FIG. 1;

FIG. 4 is a perspective view of the rear side of the cartridge of FIG. 1;

FIG. 5 is a perspective view of an ink cartridge holder which receives the ink cartridge of FIG. 1;

FIG. 6 is a top plan view of an ink cartridge being inserted into the ink cartridge holder of FIG. 5;

FIG. 7 is a top plan view of the ink cartridge of FIG. 1 with the cover removed;

FIG. 8 is a perspective view of the ink cartridge of FIG. 1 showing the cover installed;

FIG. 9 is a top plan view of the ink cartridge showing the internal cavity with an ink supply flow path with a compartment for trapping bubbles in accordance with an embodiment of the present invention;

FIG. 10 is a top plan view of the ink cartridge showing the ink supply fluid path with a compartment for trapping bubbles with a sloped surface in accordance with another embodiment of the present invention;

FIG. 11 is an enlarged view of the ink supply flow path of FIG. 10; and

FIG. 12 is a plan view of the two compartments of FIG. 11.

### DETAILED DESCRIPTION OF THE INVENTION

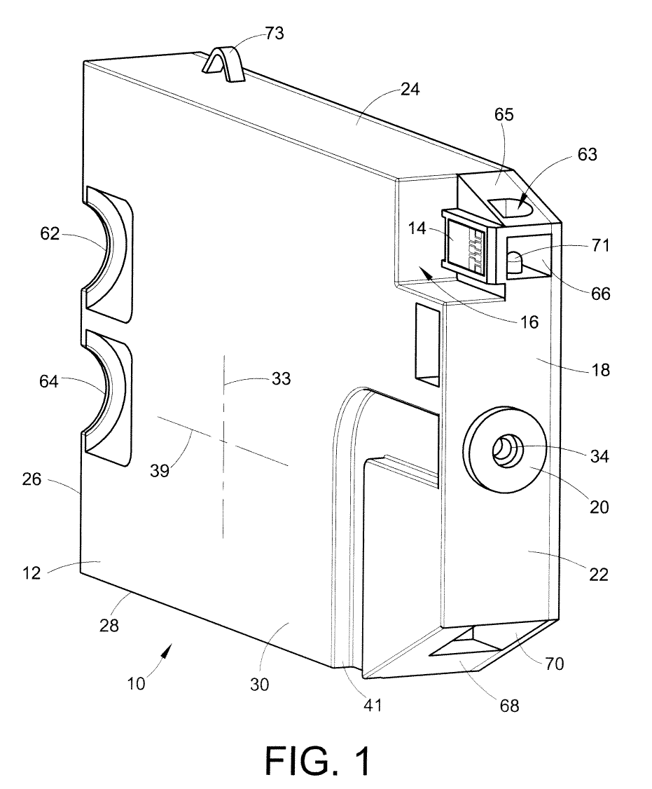

Referring now in greater detail to the drawings, wherein the showings are for the purpose of illustrating preferred embodiments of the invention only and not for the purpose of limiting the invention, FIG. 1 is a front perspective view of the ink cartridge according to the first embodiment of the present invention An ink cartridge 10 according to the first embodiment includes an ink cartridge main body 12 having a substantially rectangular parallel piped shape, an information storing unit 14 provided on a recess 16 which is adjacent a first side or a first wall 18 of the ink cartridge main body, and an ink supply unit 20 provided on a front surface 22 of wall 18. The body is formed by side walls 18, 24, 26, 28 and wall 30.

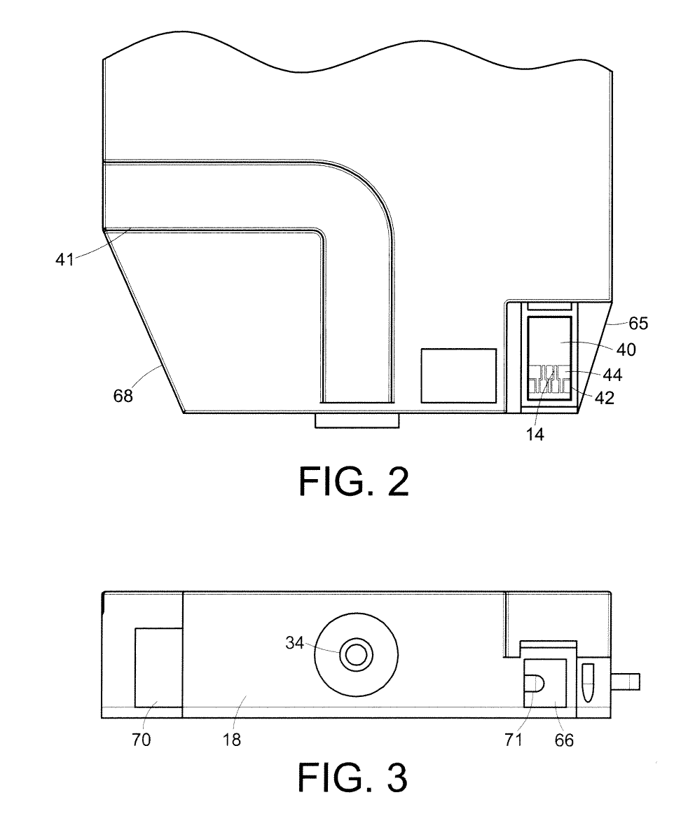

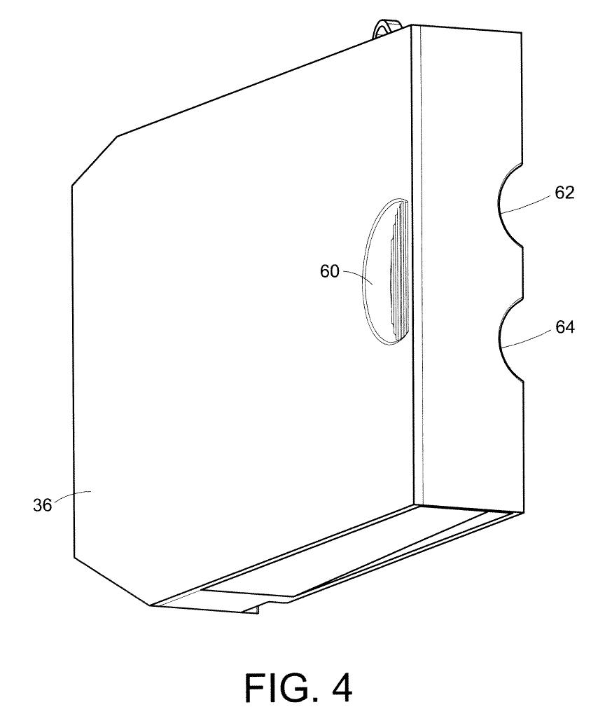

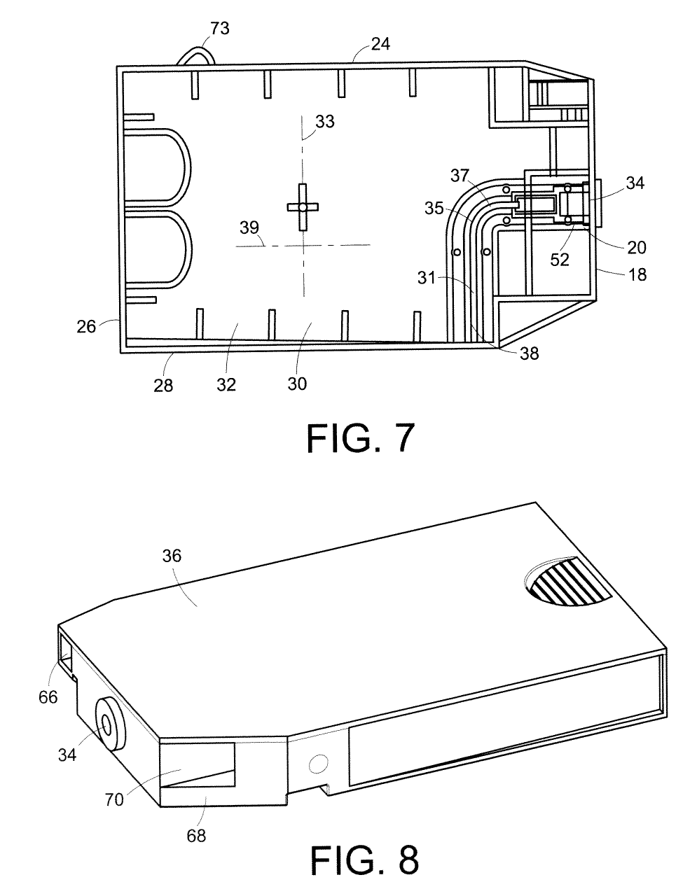

The ink cartridge main body includes a cavity 32 with one side being open, an ink supply port 34 (FIG. 3) provided at end 18 and is fixed to end 18, and a substantially flat cover plate 36 (FIG. 4). In this ink cartridge main body, the internal cavity 32 of the cartridge is substantially filled up with ink. The internal cavity 32 is formed by walls 18, 24, 26, 28, and 30 of the main body. An ink supply flow path 38 (FIG. 7) such as a channel for facilitating flow of ink from the main body to the ink supply port is provided in a recess 41 (FIG. 2) of wall 30. The channel 38 has a first, straight portion 31 extending along a first axis 33 of the body and a curved portion 35 connecting a second straight portion 37 extending perpendicular to first portion 31 and along second axis 39 of the body. The cover is fixed to the side walls 18, 24, 26, 28 of the container main body, such as by vibration, welding, or the like, with the internal cavity 32 of the container being enclosed by the cover. Thereby, a large quantity of ink is held and the large quantity of the ink is supplied to the ink jet recording apparatus stably which records on large-size papers such as posters or the like.

The information or memory storing unit 14 of the ink cartridge stores information, such as a type of ink and the ink cartridge, color of the ink in the ink cartridge, and remaining amount of the ink. For example, as shown in FIG. 2, the information storing unit is a contact type chip. The contact type chip includes a substrate 40, a connection electrode section 42 including a plurality of connection terminals 44 which are exposed to the front surface of the substrate, and memory including a semiconductor memory element, such as EEPROM provided on a back side of the substrate. The information data in the memory is read or rewritten through the connection terminals 44 electrically connecting with connection electrodes of the recording apparatus. In the present embodiment, the information storing or memory unit is of a contact type which is provided with the connection electrode section 42 including the plurality of connection terminals 44 exposed outside.

Seven connection terminals are typically arranged adjacent each other in the present embodiment as shown in FIG. 2. Alternatively, for example, the memory of the information storing unit may be provided on the other wall of the cartridge main body or the like and connects with the connection electrode section, which is provided on the first wall, via a flexible print circuit (FPC).

The recess 16 may be provided adjacent the first wall 18 of the ink cartridge main body as shown in FIG. 2. The information storing or memory unit and the connection electrode section are arranged in the recess. Moreover, since the upper part of the connection terminal surface is opened to the outside in the recess, the information storing unit is easily mounted on the ink cartridge main body during manufacturing of the ink cartridge.

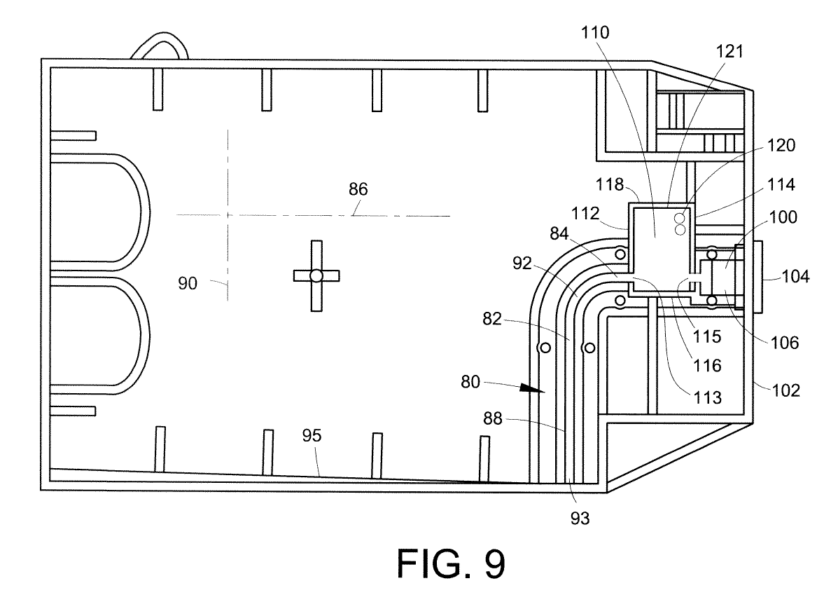

The ink supply port 34 is provided in the ink supply section of the ink cartridge, and the ink is supplied to the recording apparatus main body from the ink cartridge through the ink supply port. An ink supply needle 50 (FIG. 6) of the recording apparatus is inserted in the ink supply port. A valve or septum 52 (FIG. 9), which can be perforated or have a slit, is penetrated by insertion of the ink supply needle, and is provided within the ink supply port.

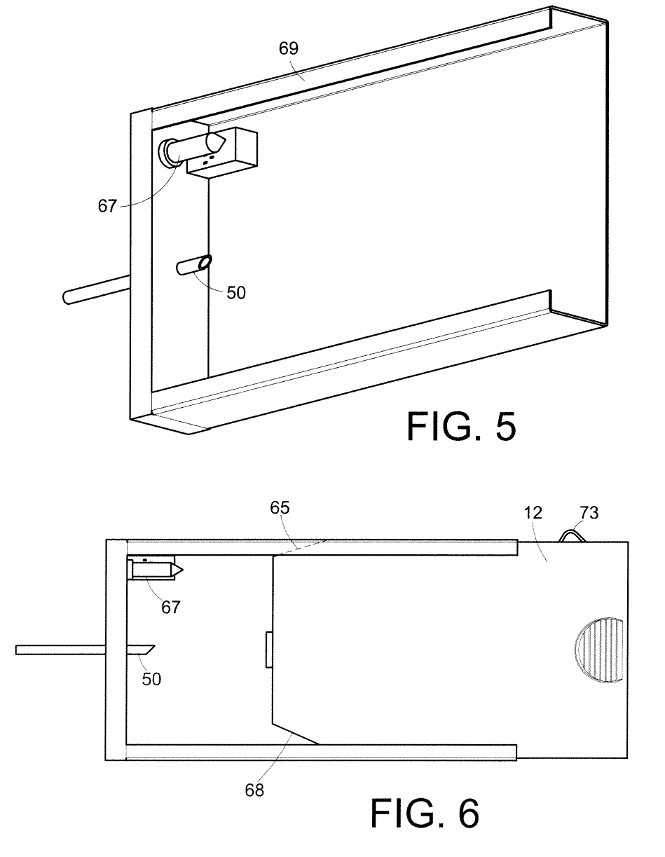

Referring to FIG. 4, in the rear side of the ink cartridge, there includes a gripping portion 60 and two finger indentations or recesses 62, 64 for enabling a user to securely grip the ink cartridge, and to easily attach/detach the ink cartridge to/from the ink cartridge holder of the ink jet recording apparatus. Referring to FIGS. 1, 3 and 8, at a front end of the cartridge, the cartridge further has a substantially square-shaped opening 66 positioned adjacent the memory unit into which a positioning rod 67 (FIG. 5) of the ink cartridge holder 69 may extend. A spring biased pin 71 may be depressed and keep a positioning rod aligned within opening 66. An angled or sloped surface 65 is formed adjacent opening 66 and the memory device 14. On the other side of the cartridge, an angled surface 68 is formed in which a slotted opening 70 is formed. A second positioning member (not shown) of the ink cartridge holder may extend into the slotted opening. A projecting member 73 (FIGS. 1, 7) extending from side wall 24 helps guide and align the cartridge into its holder. The projecting member may be flexible or biased. The angled surfaces 65 and 68 at an upper corner and a lower corner help align, locate and center the cartridge and guide it into the holder as it is inserted as seen in FIG. 6. The upper angled wall also serves as a shield for the cartridge venting mechanism (pin 71 which is spring biased) which may allow ink to escape if depressed prior to insertion into the printer. A recess 63 is also provided for the venting mechanism to catch any ink that may leak from around the vent seal during insertion.

Referring to FIG. 6, the front surface of the cartridge is inserted into the holder main body of the ink cartridge holder. Positioning members of the holder oppose opening 66 and slotted opening 70. The ink supply needle 50 of the holder is positioned opposite the ink supply port 34 of the ink cartridge. The ink cartridge is slid into the holder cavity until the connection electrodes of the information reading section of the holder controls connection terminals of the connection electrode section of the information sharing unit in the ink cartridge.

Existing cartridges which have bags or collapsible ink reservoirs have an ink supply fluid path that comes directly in contact with the printer's ink needle. Bubbles in the ink ranging in size and frequency may be formed in the ink flow path. Bubbles may also form in the ink bag, and pockets of ink may become trapped in the bag as it collapses during depletion of the ink. Thus, the efficiency of the ink cartridge is reduced. Another problem with this configuration is that air bubbles may be ingested into the printer's ink and create imaging defects. Printheads typically contain a filter for each color of ink. Over time, the bubbles formed in the ink will accumulate at the filter and impede the flow rate which is a function of the area solid coverage. Several bubbles may coalesce to form a single but larger bubble over time. Oftentimes the user uses the power cleaning setting on the printer to attempt to evacuate air from the printhead. Attempts have also been made to manually evacuate air from the printhead with a syringe to impart higher negative pressure in order to purge the air.

In accordance with a first embodiment of the present invention, FIG. 9 shows an ink cartridge having an ink supply flow path 80 having a channel 82 formed of a first straight portion 84 which extends along a longitudinal axis 86 of the cartridge body, a second straight portion 88 which extends along a second, transverse axis 90 of the cartridge substantially perpendicular to the first portion 84. A curved portion 92 extends between and connects the first straight portion and the second straight portion. The flow path has an inlet 93 adjacent a bottom wall 95 of the cartridges.

A first compartment 100 is provided adjacent wall 102 and forms a portion of an ink supply port 104. The first compartment is preferably cylindrical and houses a wick member or septum 106, which can be made of rubber or a porous material, such as foam or felt. A second compartment 110 is formed adjacent first compartment 100, and is of a generally rectangular configuration. Second compartment 110 is formed by walls 112, 114, 116, 118. Walls 112 and 114 are substantially parallel to each other and are preferably longer than walls 116, 118, which are substantially parallel to each other. Openings 113 and 115 are formed in walls 112 and 114 to allow ink to travel through the compartment. The second compartment is taller or longer than the first compartment along axis 90. Second compartment may also be wider than the first compartment along axis 86. As ink migrates through the ink supply flow path towards the ink supply port and the septum, bubbles 120 which are formed in the ink float to the ceiling or upper portion 121 of the second compartment and become trapped in the upper portion of the second compartment.

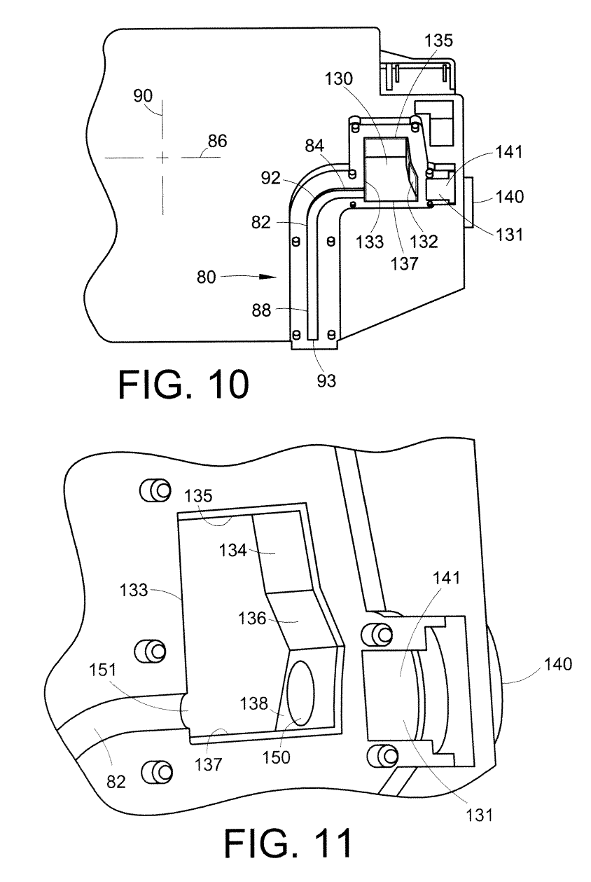

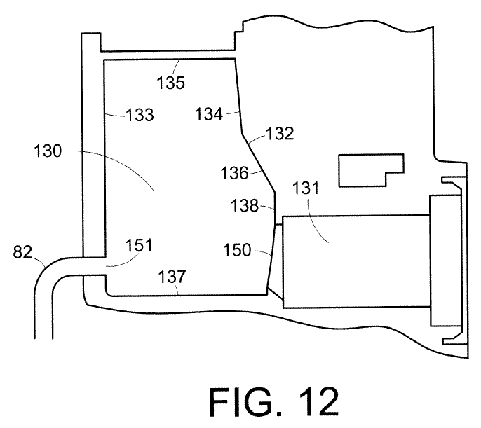

Referring now to FIGS. 10-12, a second embodiment of the present invention is shown. A single compartment or reservoir 130 is formed adjacent compartment 131 of an ink outlet port 140 of the cartridge. A wick 141 may be present in compartment 131. Compartment 130 is formed by walls 132, 133, 135, 137. Walls 132 and 133 are preferably longer than walls 135, 137 along axis 90. Walls 135 and 137 are substantially parallel to each other. Wall 137 may be longer than wall 135. Wall 132 may be longer than wall 133. The compartment 130 has a substantially rectangular configuration, with the exception of a sloped or angled upper surface 132 which is configured to allow bubbles to float to the upper surface but slide and not get stuck in a sharp edge or corner of the reservoir. Surface 132 can include a first angled or sloped surface 134, a second angled or sloped surface 136 and a third angled or sloped surface 138. Openings 150, 151 are formed in walls 132, 133 to allow ink to travel through the compartment.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An ink cartridge comprising:
a plurality of walls forming an internal cavity which is substantially filled with ink;
an ink supply flow path provided in one of said walls of said ink cartridge;
an ink supply port provided in another of said walls of said cartridge, wherein said ink supply flow path connects to said ink supply port; wherein said ink supply flow path comprises a first compartment and a second compartment, wherein said first compartment houses a wicking member, and said second compartment being configured to trap air bubbles formed within ink as it travels through the ink supply flow path.

2. The ink cartridge of claim 1, wherein said first compartment and said second compartment are adjacent to each other.

3. The ink cartridge of claim 1, wherein said second compartment is substantially rectangular in configuration.

4. The ink cartridge of claim 1, wherein said second compartment comprises walls which are longer than walls of said first compartment in a first direction.

5. The ink cartridge of claim 1, wherein said second compartment comprises a first set of walls and a second set of walls, wherein said first set of walls are longer than said second set of walls.

6. The ink cartridge of claim 1, wherein said second compartment comprises a plurality of walls, wherein one of said walls has a sloped surface.

7. The ink cartridge of claim 1, wherein said second compartment comprises a plurality of walls, wherein one of said walls comprises an angled surface.

8. The ink cartridge of claim 6, wherein said sloped surface comprises a plurality of sloped surfaces.

9. The ink cartridge of claim 7, wherein said angled surface comprises a plurality of angled surfaces.

10. The ink cartridge of claim 5, wherein said first set of walls each comprises an opening for allowing ink to pass through.

11. The ink cartridge of claim 1, wherein said wicking member comprises a porous member.

12. The ink cartridge of claim 1, wherein said wicking member comprises a porous member.
